(19) United States
(12) Patent Application Publication
(10) Pub. No.: US 2013/0162686 A1
(43) Pub. Date: Jun. 27, 2013

(54) IMAGE BROWSING APPARATUS, CONTROL METHOD OF THE IMAGE BROWSING APPARATUS AND PROGRAM

(71) Applicant: CANON KABUSHIKI KAISHA, Tokyo (JP)

(72) Inventors: Eito Sakakima, Kamakura-shi (JP); Satoshi Ukawa, Komae-shi (JP); Saloshi Hanamitsu, Hiratsuka-shi (JP); Tetsu Fukuda, Hiratsuka-shi (JP); Shinya Oda, Kawasaki-shi (JP)

(73) Assignee: CANON KABUSHIKI KAISHA, Tokyo (JP)

(21) Appl. No.: 13/716,488

(22) Filed: Dec. 17, 2012

(30) Foreign Application Priority Data
Dec. 27, 2011 (JP) 2011-286313

(51) Int. Cl. G06T 3/40

(52) U.S. Cl. CPC G06T 3/40
USPC 345/660

(57) ABSTRACT

An image browsing apparatus for displaying an image by using image data of an image group including a plurality of images at different focal lengths, detects an operation of changing a position of a displayed area, when a partial area in one of the images included in the image group is displayed, determines whether to revise the displayed image to another image of the image group on the basis of a focal position in a display area which is based on the position change, in response to the detection of the operation, selects another image with the focal position in the display area based on the position change, in a case where it is determined to revise the image to another image, and displays the display area based on the position change, of the selected image.

### BACKGROUND OF THE INVENTION

1. Field of the Invention

The present invention relates to an image browsing apparatus, a control method of the image browsing apparatus and a program for displaying an image by using image data of an image group including a plurality of images at different focal lengths.

2. Description of the Related Art

In recent years, a Multi Focus Photo (hereinafter, “MFP”) image is known, by which images are photographed plural times at a plurality of focal lengths of a same framing can be enjoyed as a series of image group. The MFP images allow obtaining together a plurality of different in-focus images of a plurality of objects of a same framing by photographing images at various focal lengths. As a result, not only one in-focus image with a photographing effect such that only a some object is focused and the other objects and background are blurred, but images with the similar effect can also be obtained for a plurality of objects. The photographed MFP images can be displayed in, for example, ascending order of the focal length in an image browsing apparatus to present a display method of expressing depth feeling to the user.

When a user performs an enlargement operation of a partial area of the MFP images in the image browsing apparatus that displays the MFP images, an object which is in an in-focus state may not exist in the partial area designated by the user. Therefore, the user needs to perform an operation of selecting an image, which is focused on an object existing in the area based on the enlargement operation, from the image group of the MFP images to revise the displayed image to browse the in-focus image.

An image browsing apparatus disclosed in Japanese Patent Application Laid-Open No. 2007-312097 has an automatic adjustment function of a focal length, wherein when a user designates a partial area in an image, an image which is focused on the area is automatically selected from the image group of MFP and displayed. As a result, the user can skip an operation of selecting an in-focus image, which is necessary after the enlargement operation.

However, in the technique described in Japanese Patent Application Laid-Open No. 2007-312097, an image which is focused on the partial area is always selected from the image group of the MFP images and displayed, after the designation of the partial area in the image by the user. Therefore, an image at a focal length not desired by the user may be displayed. For example, it is assumed that the user desires to enlarge and browse an image while maintaining the current focal length by performing an enlargement operation when the image is displayed. In this case, according to the technique described in Japanese Patent Application Laid-Open No. 2007-312097, an image focused on a center position of the enlarged image, which is the area designated by the user, is displayed based on automatic adjustment of the focal length.

The operation will be described with reference to FIG. 11. FIG. 11 illustrates a picture screen frame 1101 displayed in an image browsing apparatus. An image 1103 expressed with solid lines shows an in-focus object. An image 1104 expressed with alternate long and short dash lines shows a blurred object which is out of focus. It is assumed that the user desires to enlarge and display an area of a frame 1102 indicated by broken lines on the picture screen frame 1101, while maintaining the focal length. In the technique described in Japanese Patent Application Laid-Open No. 2007-312097, an image which is focused on a center of an area based on the enlargement operation is displayed after automatic adjustment of the focal length, as illustrated by a picture screen frame 1105 of FIG. 11. Therefore, there is a problem that automatic adjustment of the focal length not desired by the user is carried out in an operation of changing the display area, such as enlargement and reduction of a displayed image.

### SUMMARY OF THE INVENTION

An aspect of the present invention is to solve all or at least one of the problems.

According to an aspect of the present invention, an image browsing apparatus for displaying an image by using image data of an image group including a plurality of images at different focal lengths, detects an operation of changing a position of a displayed area, when a partial area in one of the images included in the image group is displayed, determines whether to revise the displayed image to another image of the image group on the basis of a focal position in a display area which is based on the position change, in response to the detection of the operation, selects another image with the focal position in the display area based on the position change, in a case where it is determined to revise the image to another image, and displays the display area based on the position change, of the selected image.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a hardware configuration of an image browsing apparatus.

FIG. 2 is a functional block diagram illustrating a functional configuration of the image browsing apparatus.

FIG. 3 is a flow chart illustrating a process of the image browsing apparatus.

FIGS. 4A, 4B, 4C and 4D are diagrams for describing an operation of changing a display area by a user operation.

FIG. 5 is a flow chart illustrating an image revising determination process of a first embodiment.

FIG. 6 is a diagram for describing transition of a display state by a user operation of the first embodiment.

FIG. 7 is a flow chart illustrating an image revising determination process of a second embodiment.

FIG. 8 is a diagram for describing transition of a display state by a user operation of the second embodiment.

FIG. 9 is a diagram for describing a method of designating a display area by a user operation of a third embodiment.

FIGS. 10A and 10B are diagrams for describing transition of a display state by a user operation of the third embodiment.

FIG. 11 is a diagram for describing a conventional technique.

### DESCRIPTION OF THE EMBODIMENTS

Various exemplary embodiments, features, and aspects of the invention will be described in detail below with reference to the drawings.

A case of using Multi Focus Photo (hereinafter, “MFP”) images as image data at different focal lengths of a same framing will be described. An image browsing apparatus displays an MFP image in an image group of the MFP images.

### First Embodiment

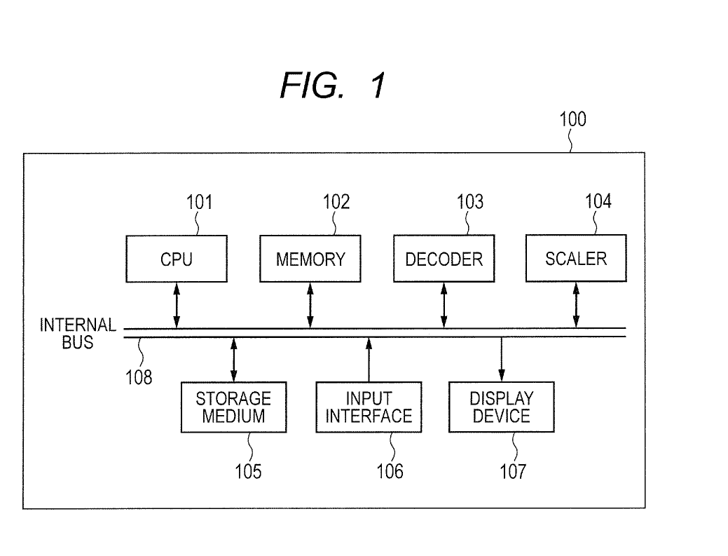

FIG. 1 is a block diagram illustrating a hardware configuration of an image browsing apparatus 100.

The image browsing apparatus 100 includes a CPU 101, a memory 102, a decoder 103, a scaler 104, a storage medium 105, an input interface 106 and a display device 107.

The CPU (Central Processing Unit) 101 is a central processing unit that controls the components of the image browsing apparatus 100. The CPU 101 controls image reading and executes a control process of image data to be displayed.

The memory 102 temporarily stores read-out image data and information attached to the image data.

The decoder 103 executes decoding processing of image data. Since the image data generally has undergone high efficiency encoding processing such as JPEG (Joint Photographic Expert Group), the decoding processing needs to be carried out to display the image data.

The scaler 104 enlarges or reduces the image data decoded by the decoder 103.

The storage medium 105 is a storage device for storing image data to be displayed. Specifically, an HDD (Hard Disk Drive) may be used, for example. The image browsing apparatus 100 reads out the image data in the storage medium 105 and executes decoding processing and scaler processing to display the image data.

The input interface 106 executes a process of acquiring various user operations from the user to transmit the user operations to the CPU 101. Examples of the various user operations include a power control instruction of the image browsing apparatus 100, a selection instruction of the image data to be displayed, and an enlargement or reduction instruction of the displayed image data.

The display device 107 displays the decoded image data. Although the display device 107 is one of the components of the image browsing apparatus 100 in FIG. 1, the display device 107 may be a separate individual component.

The pieces of hardware described above are connected through an internal bus 108, and data is transferred through the internal bus 108.

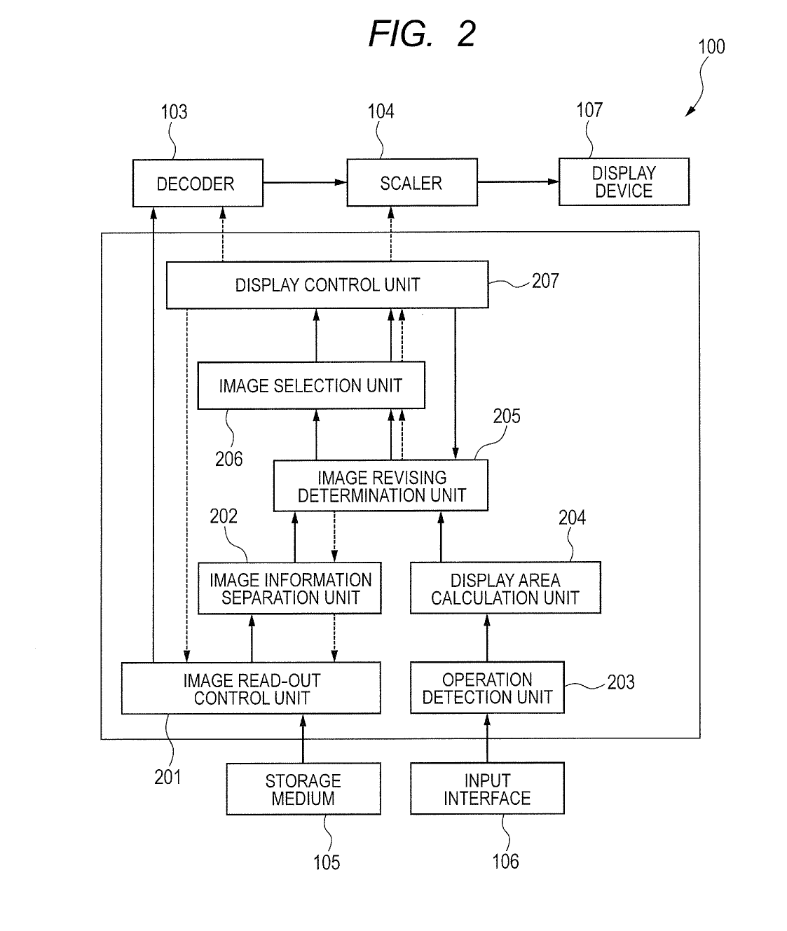

A functional configuration of the image browsing apparatus 100 will be described with reference to a block diagram of FIG. 2. The CPU 101 basically reads out the programs stored in the storage medium 105 into the memory 102 to execute the programs to realize the functional blocks illustrated in FIG. 2. The same hardware as in FIG. 1 is denoted with the same reference numerals, and the description will not be repeated.

The image browsing apparatus 100 includes an image read-out control unit 201, an image information separation unit 202, an operation detection unit 203, a display area calculation unit 204, an image revising determination unit 205, an image selection unit 206 and a display control unit 207.

The image read-out control unit 201 reads out the image data recorded in the storage medium 105 based on an instruction from another functional configuration unit. Specifically, the image data of the MFP images used in the present embodiment is included in an MFP image file. Therefore, the image read-out control unit 201 executes a process of reading out the MFP image file and transmitting the MFP image file to the decoder 103 and the image information separation unit 202. The decoder 103 executes decoding processing of the transmitted MFP image file. The image information separation unit 202 separates accompanied information of the transmitted MFP image file. More specifically, the image information separation unit 202 executes a process of separating the accompanied information included in the MFP image file transferred by the image read-out control unit 201 from the image data of the MFP images. Specifically, in the MFP image file, the image information separation unit 202 separates focal position information of the MFP images along with identifiers for identifying the MFP images. The focal position information is information indicating focal positions on the MFP images by using, for example, (X, Y) coordinate values. The image information separation unit 202 transfers the separated focal position information and identifiers to the image revising determination unit 205.

The operation detection unit 203 detects various user operations for the displayed MFP images input from the input interface 106. For example, the operation detection unit 203 detects an operation for changing a display area of the displayed MFP image, or specifically, an operation for enlarging, reducing, or moving the display area. The operation detection unit 203 transmits the detected user operation information to the display area calculation unit 204.

The display area calculation unit 204 calculates the change in the display area on the basis of the user operation information transmitted by the operation detection unit 203. The display area calculation unit 204 transmits information of the display area calculated based on the user operation to the image revising determination unit 205.

The image revising determination unit 205 determines whether to revise the displayed MFP image to another MFP image in the image group of the MFP images on the basis of the information of the display area based on the user operation transmitted by the display area calculation unit 204 and on the basis of the focal position information. The image revising determination unit 205 acquires the focal position information necessary for the determination from the image information separation unit 202.

Based on the result of the determination by the image revising determination unit 205, the image selection unit 206 selects the image data of the MFP image to be displayed on the display device 107 from the MFP image file stored in the storage medium 105. The image data of the selected MFP image is read out using the image read-out control unit 201.

The display control unit 207 executes control for displaying the image data of the MFP image selected by the image selection unit 206 on the display device 107. Specifically, the display control unit 207 uses the information of the display area calculated by the display area calculation unit 204 to control the decoder 103 and the scaler 104, thereby setting and displaying the display area according to the user operation input from the input interface 106 to show it to the user.

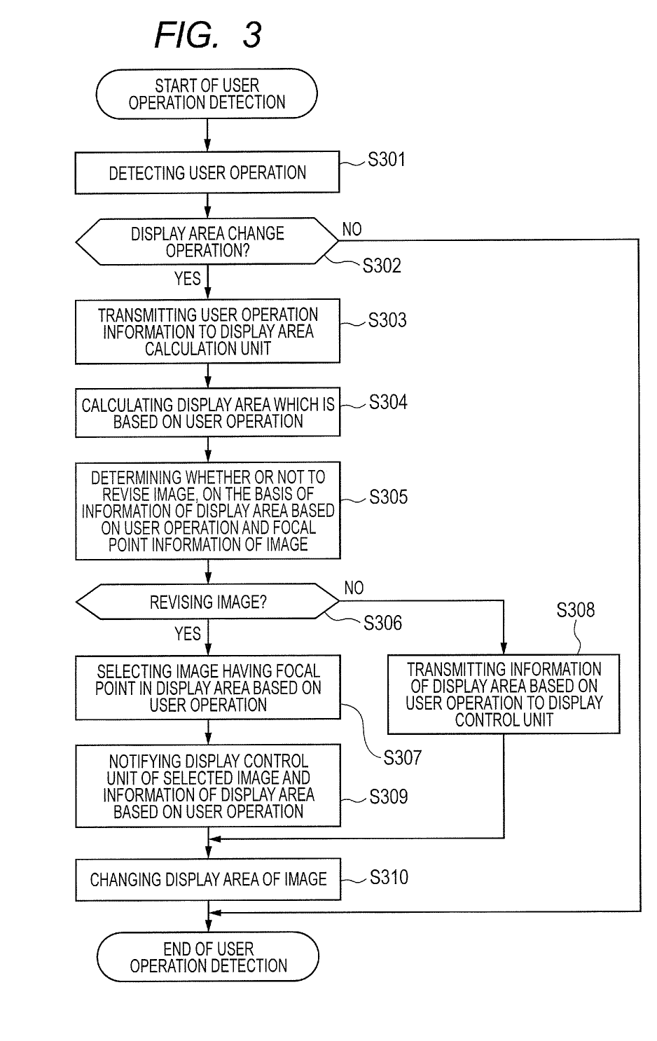

Operation of the image browsing apparatus 100 will be described with reference to a flow chart of FIG. 3 and with reference to FIG. 2. FIG. 3 is a flow chart illustrating a process of determining whether to revise the displayed image based on the user operation of changing the display area of the image, to revise the image in accordance with the determination. Each step will now be described.

In step S301, the operation detection unit 203 detects an operation by the user.

In step S302, the operation detection unit 203 determines whether the detected operation is an operation for changing the display area of the displayed image.

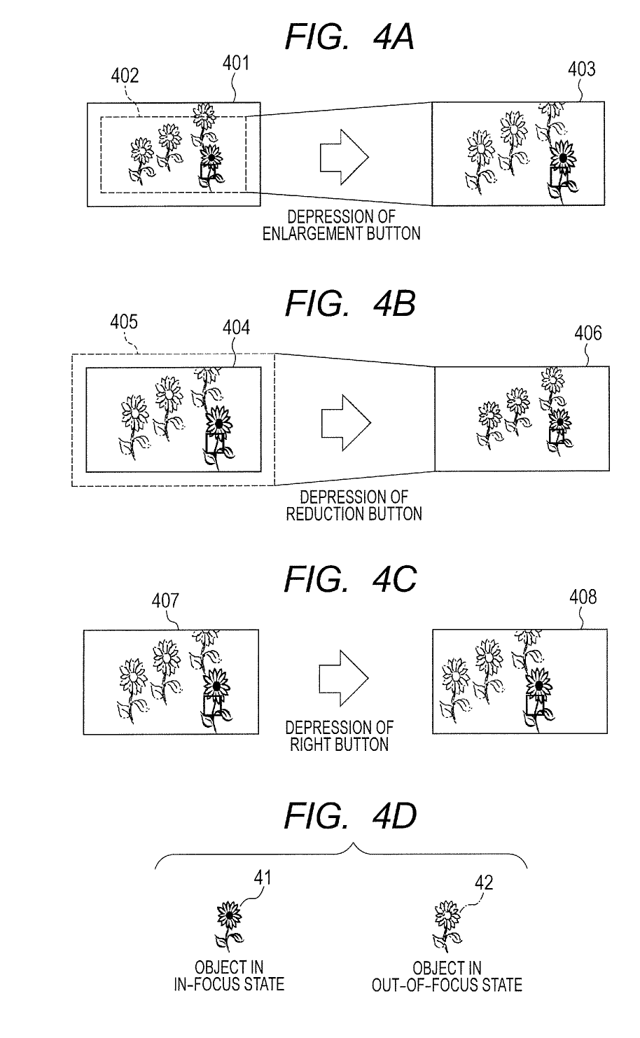

The operation for changing the display area will be described here with reference to FIGS. 4A to 4D. FIGS. 4A to 4D are diagrams illustrating transition of a display state before and after the change based on the operation for changing the display area of the image. In the following description, an image 41 expressed by solid lines is an object which is in focus, and an image 42 expressed by alternate long and short dash lines is a blurred object which is out of focus, as illustrated in FIG. 4D.

An operation by a remote controller of the image browsing apparatus 100 is assumed for the operation of changing the display area. The user depresses an enlargement button arranged on the remote controller to perform an enlargement operation and depresses a reduction button to perform a reduction operation to change the display area.

FIG. 4A illustrates display states of the image in a case where the enlargement operation is performed. A picture screen frame 401 illustrates a display state prior to the enlargement operation, and a picture screen frame 403 illustrates a display state based on the enlargement operation. An area extending up to a frame 402 of broken lines in the picture screen frame 401 is enlarged in accordance with the depression of the enlargement button of the remote controller by the user, and the enlarged area is displayed in the picture screen frame 403.

FIG. 4B illustrates display states of the image in a case where the reduction operation is performed. A picture screen frame 404 illustrates a display state prior to the reduction operation, and a picture screen frame 406 illustrates a display state based on the reduction operation. An area extending up to a frame 405 of broken lines in the picture screen frame 404 is reduced in accordance with the depression of the reduction button of the remote controller by the user, and the area is displayed in the picture screen frame 406.

FIG. 4C illustrates display states of the image in a case where a movement operation is performed. A picture screen frame 407 illustrates a display state prior to the movement operation, and a picture screen frame 408 illustrates a display state based on the movement operation. A wide range of the image is displayed on the display device 107 in accordance with the movement operation. The movement operation can be performed by an up button, a down button, a right button and a left button of the remote controller. The entire display area of the picture screen frame 407 moves to the left in accordance with the depression of the right button of the remote controller by the user, and the moved area is displayed in the picture screen frame 408.

In step S302, if it is determined that the user operation indicates change of the display area as illustrated in FIGS. 4A to 4C, the process proceeds to step S303. On the other hand, if it is determined that the user operation does not indicate change of the display area, the detection of the user operation is finished, and detection of the next user operation is started.

In step S303, the operation detection unit 203 transmits the user operation information to the display area calculation unit 204.

In step S304, the display area calculation unit 204 calculates the display area which is based on the user operation and transmits the information of the calculated display area to the image revising determination unit 205.

In step S305, the image revising determination unit 205 executes an image revising determination process. Specifically, the image revising determination unit 205 determines whether to revise the image to be displayed to another image in the image group of the MFP images on the basis of the information of the display area calculated based on the user operation and on the basis of the focal position information of the image.

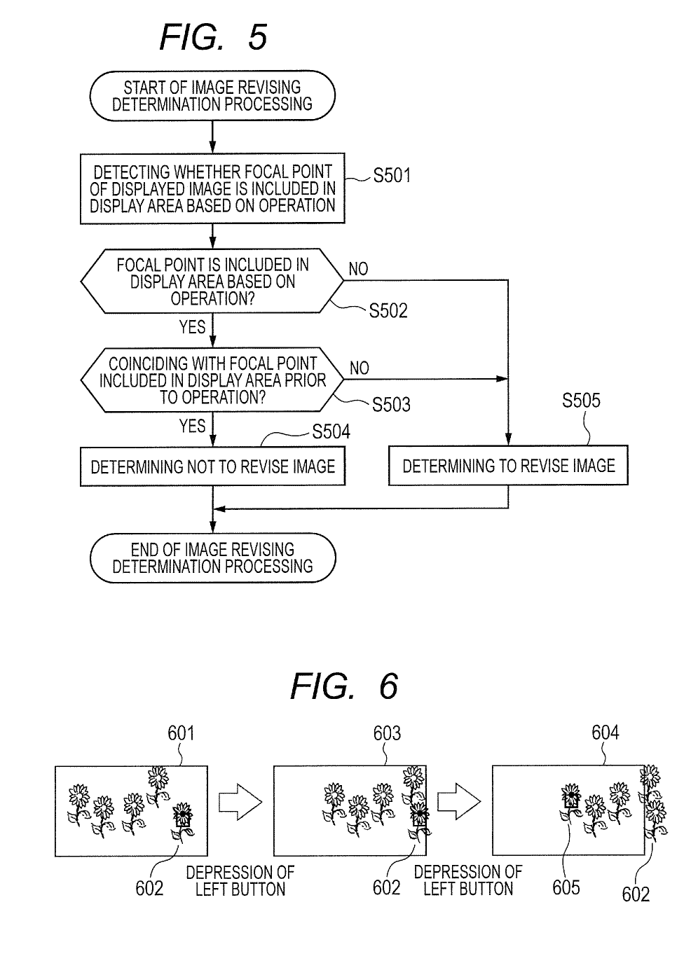

The image revising determination process of step S305 will be described with reference to a flow chart of FIG. 5. The flow chart of FIG. 5 illustrates the process of determining whether to revise the image executed in step S305 from the start to the end thereof.

In step S501, the image revising determination unit 205 determines whether the display area based on the user operation includes the focal position. Specifically, the image revising determination unit 205 detects the focal position on the basis of the focal position information of the displayed image to detect, based on the display area information, whether the detected focal position is included in the display area changed by the user operation. Therefore, this detection of the focal position is conducted all over a range of the entire area of the displayed area, not only from the display area.

In step S502, the image revising determination unit 205 determines whether the focal position is included in the display area to be changed on the basis of the result of the detection in step S501. If it is determined that the focal position is included, the process proceeds to step S503. If it is determined that the focal position is not included, the process proceeds to step S505.

In step S503, the image revising determination unit 205 determines whether the focal position determined to be included in the changed display area in step S502 coincides with the focal position in the display area prior to the user operation. If the focal positions coincide, the process proceeds to step S504, and the image revising determination unit 205 determines not to revise the image. On the other hand, if the focal positions are different, the process proceeds to step S505, and the image revising determination unit 205 determines to revise the image. In the revision of the image, the image selection unit 206 selects an image different from the currently displayed image from the image group of the MFP images as described later, and the display control unit 207 displays the selected image on the display device 107.

Returning to the flow chart of FIG. 3, the image revising determination unit 205 determines whether to revise the image in step S306 on the basis of the image revising determination process. The process proceeds to step S307 if it is determined to revise the image. The process proceeds to step S308 if it is determined not to revise the image. In a case where the image is not revised, only a process of changing the display area of the currently displayed image is executed. Therefore, in step S308, the image revising determination unit 205 transmits the information of the display area based on the user operation to the display control unit 207, and the process proceeds to step S310.

In step S307, the image selection unit 206 selects an image that includes the focal position in the display area based on the user operation, or specifically, an image that includes the focal position closest to the center position in the display area based on the user operation, from the image group of the MFP images.

In step S309, the image selection unit 206 transmits the identifier of the selected image and the information of the display area based on the user operation to the display control unit 207, and the process proceeds to step S310.

In step S310, the display control unit 207 sets the display area of the image based on the display area information so that the selected image coincides with the display area based on the user operation and displays the set image on the display device 107. When the process is advanced from step S308 to step S310, since the image is not revised, the display control unit 207 only changes the display area for the currently displayed image.

The image browsing apparatus 100 can revise the image according to the user operation as a result of the process of the flow charts illustrated in FIGS. 3 to 5.

A movement operation will be specifically illustrated as an example of the user operation to describe transition of the image display with reference to FIG. 6. The meaning of the solid lines and the alternate long and short dash lines of the objects is the same as in FIG. 4D.

A picture screen frame 601 of FIG. 6 is in the display state of the image prior to the movement operation. The picture screen frame 601 displays an image which is focused on an object 602.

A picture screen frame 603 illustrates a display state in a case where the user depresses the left button in the display state of the picture screen frame 601. A case of applying an algorithm of the image revising determination process in the flow chart illustrated in FIG. 5 in accordance with an operation of movement from the picture screen frame 601 to the picture screen frame 603 will be described. In the picture screen frame 603, the focal position is included in the display area based on the user operation and coincides with the focal position prior to the user operation. Therefore, the process proceeds to step S502, step S503 and step S504, and the image revising determination unit 205 determines not to revise the image. As a result, in the picture screen frame 603 illustrated in FIG. 6, the same image as that of the picture screen frame 601 is displayed and only the display area is changed.

A picture screen frame 604 illustrates a display state in a case where the user depresses the left button again from the state of the picture screen frame 603. As a result of this depression of the left button, the object 602 moves from the display area to the outside of the picture screen frame 604. Since the focal position is not included in the display area based on the user operation in the picture screen frame 604, the process proceeds to step S502 and step S505. Therefore, the image revising determination unit 205 determines to revise the image. As a result, in the picture screen frame 604 illustrated in FIG. 6, an image which is focused on an object 605 at the focal position closest to the center position is displayed.

For example, unlike the case described above, a case in which there is also a focal position at the object 605 of the displayed image when the object 602 moves from the display area to the outside in accordance with the depression of the left button in the display state of the picture screen frame 603 will be assumed. In this case, although the process proceeds from step S502 to step S503, the focal position does not coincide with the focal position in the display area prior to the user operation. Therefore, the process proceeds from step S503 to step S505, and the image revising determination unit 205 determines to revise the image. As a result, the changed picture screen frame 604 displays an image with the focal position closest to the center position. However, since the image with the focal position closest to the center position is the image which is focused on the object 605, the image is revised to the same image.

In this way, when the user performs an operation of changing the display area of the displayed image in the present embodiment, whether to revise the displayed image to another image in the image group of the MFP images is determined based on the changed display area and the focal position in the displayed image. Therefore, the image is not always revised, and an image at a desired focal length can be displayed.

### Second Embodiment

In a second embodiment, the algorithm for determining whether to revise the displayed image to another image of the image group of the MFP images in a case where an operation of changing the display area is performed by the user operation is different from that of the first embodiment. The hardware configuration, the functional configuration and the overall flow chart for realizing the second embodiment are the same as those of the first embodiment, and the description will not be repeated.

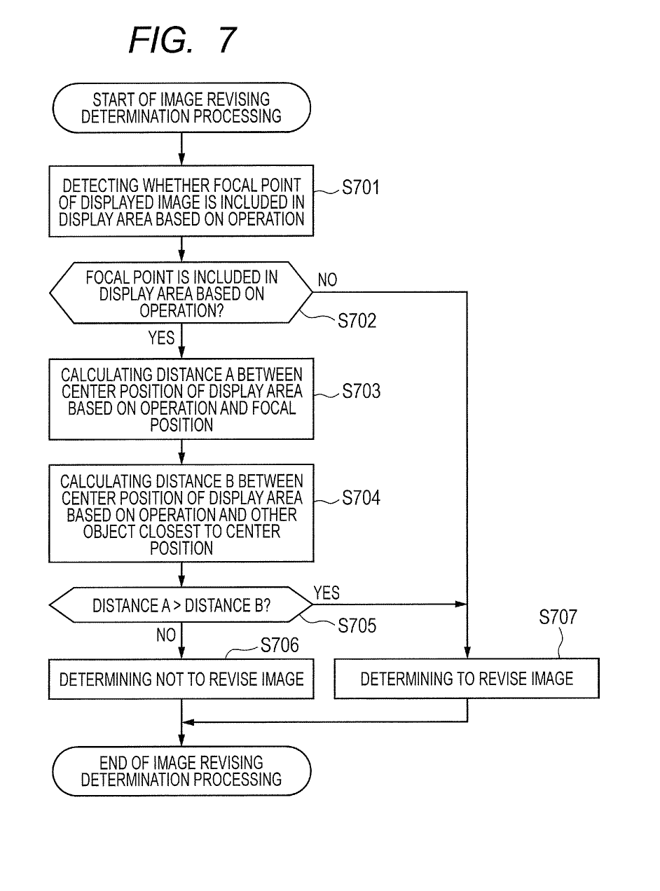

An image revising determination process in the second embodiment will be described with reference to a flow chart illustrated in FIG. 7. The image revising determination process illustrated in FIG. 7 is a process executed by the image revising determination unit 205 in step S305 illustrated in FIG. 3.

In step S701, the image revising determination unit 205 determines whether the focal position is included in the display area which is based on the user operation. The process is the same process as step S501 illustrated in FIG. 5, and the description will not be repeated.

In step S702, the image revising determination unit 205 determines whether the focal position is included in the display area to be changed based on the result of the detection in step S701. If it is determined that the focal position is included, the process proceeds to step S703. If it is determined that the focal position is not included, the process proceeds to step S707.

In step S703, the image revising determination unit 205 calculates a distance between the center position of the display area based on the user operation and the current focal position in the display area based on the user operation. The distance calculated in step S703 is defined as a distance A.

In step S704, the image revising determination unit 205 calculates a distance between the center position of the display area based on the user operation and another object closest to the center position among the objects which are out of focus in the currently displayed image and are in the display area based on the user operation. The distance calculated in step S704 is defined as a distance B.

It is assumed that objects photographed with the focal length of infinity are not included in the above-described another objects close to the center position. For example, objects which are focused at the focal length that is the farthest among the series of images at different focal lengths are not employed as an object. Alternatively, objects which are focused in images at focal lengths greater than a predetermined focal length among the series of images at different focal lengths are not employed as an object.

This prevents frequent revision of images which are focused at the infinity, in a case where the center of the display area is a background section after the change or movement of the display area.

In step S705, the image revising determination unit 205 compares the values of the distance A and the distance B. If the distance A is not greater than the distance B, the process proceeds to step S706. If the distance A is greater than the distance B, the process proceeds to step S707.

In step S706, the image revising determination unit 205 determines not to revise the image. On the other hand, the image revising determination unit 205 determines to revise the image in step S707. The image is not revised to an image with the focal length at the infinity in accordance with the process of S704. Therefore, if the user wishes to revise the image to an image with the focal length at the infinity, this may be realized by moving the center of the display area to the background section and performing a specific operation (for example, double click or holding down the SHIFT key). The specific operation may be applied with an arbitrary operation as a design choice matter.

According to the process, it is determined to revise the image if there is an object closer to the center position than to the focal position of the image displayed prior to the user operation, in a case where the display area is changed by the user operation.

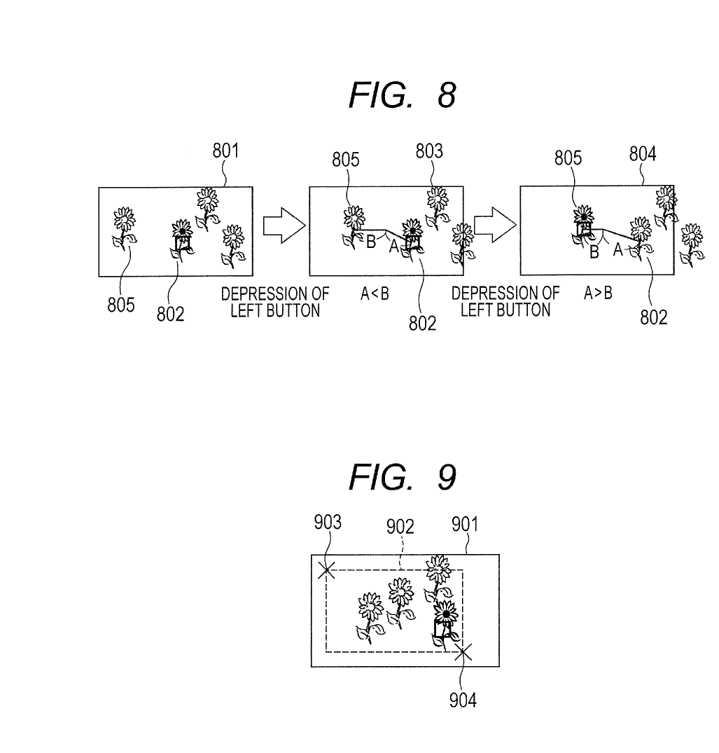

A movement operation will be specifically illustrated as an example of the user operation to describe transition of the image display with reference to FIG. 8. The meaning of the solid lines and the alternate long and short dash lines of the objects is the same as in FIG. 4D.

A picture screen frame 801 of FIG. 8 illustrates image display prior to the movement operation. The picture screen frame 801 displays an image which is focused on an object 802.

A picture screen frame 803 illustrates a display state when the user depresses the left button in the display state of the picture screen frame 801. A case of applying an algorithm of the image revising determination process in the flow chart illustrated in FIG. 7 in accordance with an operation of movement from the picture screen frame 801 to the picture screen frame 803 will be described. In the picture screen frame 803, the image revising determination unit 205 compares the distance A between the center position of the display area based on the user operation and the object 802 at the in-focus position with the distance B between the center position of the display area based on the user operation and an object 805 closest to the center position. Since the distance A is smaller than the distance B, the process proceeds from step S705 to step S706 of FIG. 7, and the image revising determination unit 205 determines not to revise the image. Therefore, in the picture screen frame 803 illustrated in FIG. 8, the same image as in the picture screen frame 801 is displayed and only the display area is changed.

A picture screen frame 804 illustrates a display state when the user depresses the left button again in the display state of the picture screen frame 803. The object 802 is further away from the center position in the picture screen frame 804 in accordance with the depression of the left button. The image revising determination unit 205 compares the distance A between the center position of the display area based on the user operation and the object 802 at the in-focus position with the distance B between the center position of the display area based on the user operation and the object 805 closest to the center position. Then, the distance A is greater than the distance B, the process proceeds from step S705 to step S707 illustrated in FIG. 7, and the image revising determination unit 205 determines to revise the image. Therefore, the picture screen frame 804 illustrated in FIG. 8 displays an image which is focused on the object 805 with the focal position closest to the center position.

In the present embodiment, whether to revise an image to another image of the image group of the MFP images is determined similarly to the first embodiment. Therefore, the image is not always revised, and an image at a desired focal length can be displayed. Particularly, the distances between the center position and the focal position in the changed display area and between the center position and the object can be determined to discriminate the object observed by the user, thereby displaying an image which is more reflective of the intension of the user.

### Third Embodiment

In a third embodiment, a method of arbitrarily designating a change in the display area by the user operation will be described. The hardware configuration, the functional configuration and the overall flow chart for realizing the third embodiment are the same as those of the first embodiments, and the description thereof will not be repeated. The processes described in the first and second embodiments are applied to the image revising determination process of the image revising determination unit 205.

FIG. 9 is a diagram for describing a method of designating the display area in the image browsing apparatus 100. A picture screen frame 901 illustrates a display area of the currently displayed image and indicates a range in which the user can browse the image. An area designating frame 902 illustrated with broken lines indicates a frame for designating the display area to be changed by the user. A left-hand upper cardinal point 903 (first cardinal point) and a right-hand lower cardinal point 904 (second cardinal point) can be designated to specify the area designating frame 902 as a rectangular area with a diagonal based on the left-hand upper cardinal point 903 and the right-hand lower cardinal point 904. The user can change the positions of the left-hand upper cardinal point 903 and the right-hand lower cardinal point 904 to designate an arbitrary frame. Specifically, the user uses an input device (not illustrated), such as a remote controller, a mouse, and a touch panel arranged on the display device 107, to designate an arbitrary area designating frame, and the operation detection unit 203 detects the position of the area designating frame through the input interface 106. The user depresses a confirmation button after the designation of the area designating frame, and the image browsing apparatus 100 displays the area designating frame on the display device 107 as a display area.

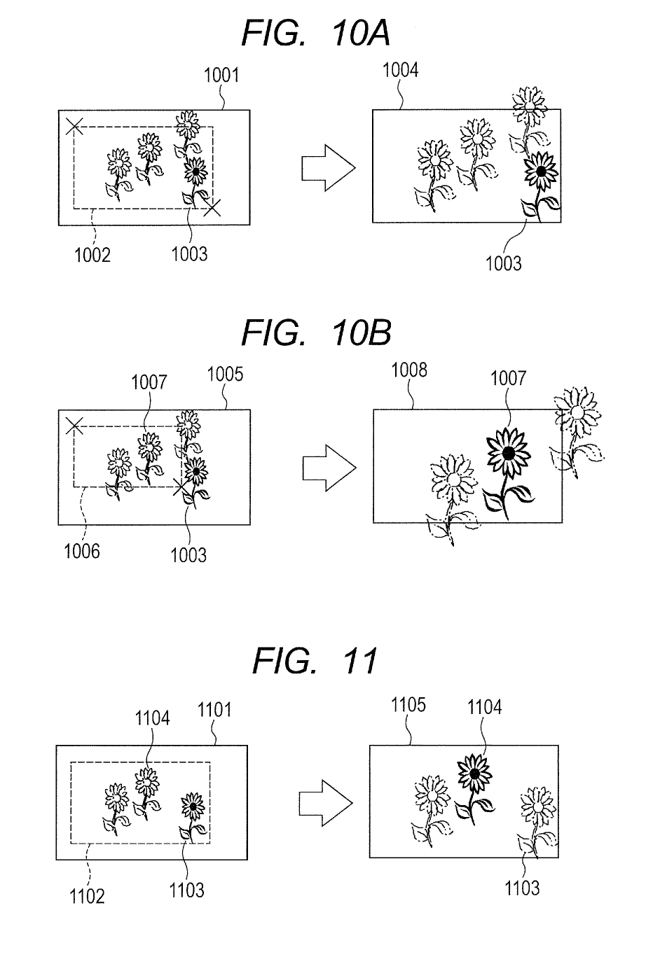

Transition of the image display based on the designation method of the area designating frame will be described with reference to FIGS. 10A and 10B. The meaning of the solid lines and the alternate long and short dash lines of the objects is the same as that of FIG. 4D. The flow chart illustrated in FIG. 5 in the first embodiment is applied as an algorithm of the image revising determination process.

A picture screen frame 1001 of FIG. 10A illustrates a display state prior to the operation of the display area. When the user instructs an operation for changing the display area on the basis of an area designating frame 1002, an in-focus object 1003 is included in the area designating frame 1002. Therefore, the image revising determination unit 205 determines not to revise the image, and there is transition to a picture screen frame 1004 illustrated in FIG. 10A, wherein the image is the same as in the picture screen frame 1001, and the display area is different.

A picture screen frame 1005 of FIG. 10B illustrates a display state before the operation of the display area. When the user instructs an operation for changing the display area on the basis of an area designating frame 1006, the area designating frame 1006 does not include the in-focus object 1003. Therefore, the image revising determination unit 205 determines to revise the image. The image is revised by selecting an image which is focused on an object 1007, from the image group of the MFP images, and there is transition to a picture screen frame 1008 illustrated in FIG. 10B.

When the display area of the image displayed by the user is changed, the user may desire to view the image in an arbitrary display area designated by the area designating frame without changing the focal position. Even in such a case, an image which is more reflective of the user's intension can be displayed according to the present embodiment. According to the first to third embodiments, in a case where the display area of the image displayed by the user is changed, whether to revise the displayed image to another image in the image group of the MFP images is determined based on the changed display area and the focal position in the displayed image. Therefore, the image is not always revised, and an image at a desired focal length can be displayed. Therefore, the user does not have to select a desired image, and the convenience of the user can be improved.

Programs stored in a storage medium or a memory of a computer can be operated to realize the units included in the image browsing apparatus and the steps of the control method of the image browsing apparatus according to the embodiments of the present invention. The programs and a computer-readable recording medium recording the programs are included in the present invention.

The present invention can also be embodied as, for example, a system, an apparatus, a method, a program and a recording medium, and specifically, the present invention may be applied to a system including a plurality of apparatuses.

The present invention directly or remotely supplies programs of software for realizing the functions of the embodiments to a system or an apparatus. The present invention also includes a case in which a computer of the system or the apparatus reads out and executes the supplied program codes to attain the functions.

Although the present invention has been described along with various embodiments, the present invention is not limited to the embodiments, and changes can be made within the scope of the present invention. For example, the case of using the image group of the MFP images as the image group including a plurality of images at different focal lengths has been described in the embodiments.

However, the present invention is not limited to the case, and an image group photographed by the user through manual photographing of a plurality of images at different focal lengths can also be used.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-286313, filed on Dec. 27, 2011, which is hereby incorporated by reference herein in its entirety.

What is claimed is:

1. An image browsing apparatus for displaying an image by using image data of an image group including a plurality of images at different focal lengths to display an image, comprising:
an operation detection unit that detects an operation of changing a position of a displayed area, when a partial area in one of the images included in the image group is displayed;
a determination unit that determines whether to revise the displayed image to another image of the image group on the basis of a focal position in a display area which is based on the position change, in response to the detection of the operation by the operation detection unit;
an image selection unit that selects another image with the focal position in the display area based on the position change, in a case where the determination unit determines to revise the image to another image; and
a display control unit that displays the display area based on the position change, of the image selected by the image selection unit.

2. The image browsing apparatus according to claim 1, wherein
the determination unit determines to revise the displayed image to another image of the image group, in a case where a focal position is not included in the display area based on the position change.

3. The image browsing apparatus according to claim 1, wherein
the image selection unit revises the image to an image in which an object included in the changed display area is at the focal position.

4. The image browsing apparatus according to claim 1, wherein
In a case where the display area based on the position change includes a plurality of objects, the image selection unit selects an image in which the focal position is in the object having the shortest distance among a distance between each object and the center position of the display area.

5. The image browsing apparatus according to claim 1, wherein
the determination unit determines whether to revise the displayed image to another image of the image group on the basis of the focal position information, attached to the image, indicating the focal position on the image.

6. The image browsing apparatus according to claim 1, wherein
the operation detection unit detects a user operation of designating a rectangular area on the displayed image.

7. A control method of an image browsing apparatus for displaying an image on a display unit by using image data of an image group including a plurality of images at different focal lengths, the control method comprising the steps of:
detecting an operation of changing a position of an area displayed on the display unit, when a partial area in one of the images included in the image group is displayed;
determining whether to revise the image displayed on the display unit to another image of the image group on the basis of a focal position in a display area which is based on the position change, in response to the detection of the operation in the detecting step;
selecting another image with the focal position in the display area based on the position change, in a case where it is determined in the determining to revise the image to another image; and
displaying, on the display unit, the display area based on the position change, of the image selected in the selecting step.

8. A non-transitory computer-readable storage medium storing a program comprising a program code for causing a computer to execute the control method according to claim 7.
